(19) United States
(12) Patent Application Publication
(10) Pub. No.: US 2015/0199640 A1
(43) Pub. Date: Jul. 16, 2015

(54) SOCIAL LEARNING PLATFORM TRACKING CONTRIBUTIONS FROM VOLUNTEERS

(71) Applicant: Eduko Foundation, Mountain View, CA (US)

(72) Inventor: Rohun Saxena, Mountain View, CA (US)

(73) Assignee: Eduko Foundation, Mountain View, CA (US)

(21) Appl. No.: 14/152,213

(22) Filed: Jan. 10, 2014

(51) Int. Cl. G06Q 10/06

(52) U.S. Cl. CPC G06Q 10/063114

(57) ABSTRACT

An online social learning platform receives questions from users. Other users submit answers to the questions on the social learning platform. The platform tracks the contributions of the users who submit answers and rewards them by crediting their accounts on the social learning platform with volunteer time. The platform generates reports of the users' accumulated volunteering hours that the users can submit to their respective schools for credit towards requirements to spend time volunteering, for example, to earn their high school diplomas.

### BACKGROUND

1. Technical Field

This invention pertains to an online social learning platform for asking and answering questions.

2. Description of Related Art

Many online platforms currently exist for users to ask questions and for other users to answer. For example, users of the YAHOO! ANSWERS platform (available at http://answers.yahoo.com/) can pose a question on any topic and receive responses from other users. However, such general question/answer platforms are of limited utility to students who are seeking help learning new concepts because there is little incentive for users to submit quality answers. As a result, many questions remain unanswered and the quality of the answers varies wildly.

### SUMMARY

An online social learning platform receives questions from users. Other users submit answers to the questions through a user interface of the social learning platform. The platform tracks the contributions of the users who submit answers and rewards them by crediting their accounts on the social learning platform with volunteer time. The platform generates reports of the users' accumulated volunteering hours that the users can submit to their respective schools for credit towards requirements to spend time volunteering, for example, to earn their high school diplomas.

Embodiments of the computer-readable storage medium store computer-executable instructions for performing the steps described above. Embodiments of the system further comprise a processor for executing the computer-executable instructions.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 is a block diagram of a computing environment of a social learning platform, in accordance with an embodiment.

FIG. 2 is a flow chart illustrating a method of tracking volunteer time for submitting answers to questions on a social learning platform, in accordance with an embodiment of the invention.

FIG. 3 is a flow chart illustrating a method of rewarding a user for helpful answers to questions on a social learning platform, in accordance with an embodiment of the invention.

FIG. 4 is an example user interface for a subject dashboard of a social learning platform, in accordance with an embodiment of the invention.

FIGS. 5A and 5B are example user interfaces for answering a question on a social learning platform, in accordance with an embodiment of the invention.

FIG. 6 is an example user interface for a member dashboard on a social learning platform showing accumulated volunteering time, in accordance with an embodiment of the invention.

FIG. 7 is a high-level block diagram of the components of a computing system.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### Overview

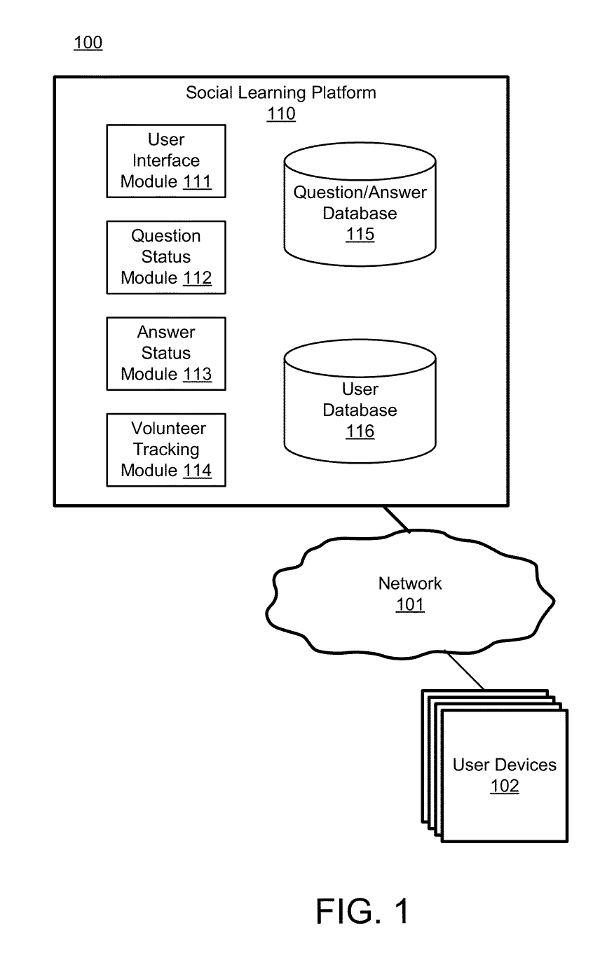

FIG. 1 is a block diagram of a computing environment 100 of a social learning platform 110, in accordance with an embodiment. The computing environment 100 includes a plurality of user devices 102 and a social learning platform 110, connected by a network 101.

The user devices 102 are computing devices, such as personal computers, laptop computers, tablet computers, and smartphones, that users use to access the social learning platform 110 over the network 101. Users can use the user devices 102 to submit questions and answers, view the status of questions and answers, and access reports of their contributions to the social learning platform 110.

The social learning platform 110 provides an online exchange of education-related questions and answers. The social learning platform 110 includes a user interface module 111, a question status module 112, an answer status module 113, a volunteer tracking module 114, a question/answer database 115, and a user database 116.

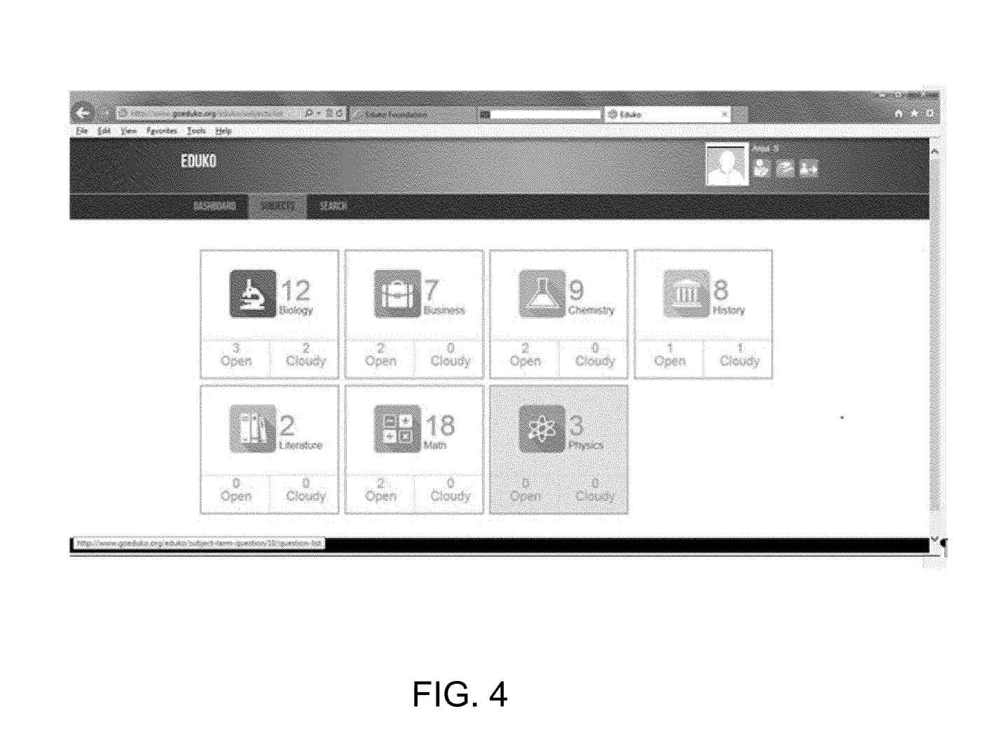

The user interface module 111 displays a user interface that allows a user that accesses the social learning platform to login, enter new questions, browse questions and answers, enter answers, enter feedback on the helpfulness of answers, and view reports of the user's volunteering time. Examples of a user interface in accordance with an embodiment of the invention are described below with reference to FIGS. 4-6.

The question status module 112 updates the status of each question. When initially submitted, each new question is assigned a status of “unanswered” or “open” or the like to indicate that the user's question has not yet been answered. When an answer to a question has been submitted, the question status module 112 updates the status of the question to “answered” or “closed” and/or updates a tally of the number of answers to the questions that have been logged.

The answer status module 113 updates the status of the answer in response to any feedback on the answer received from users. In one embodiment, only the user who submitted the question is allowed to judge if the answer was helpful or not. In another embodiment, any other user can submit feedback on an answer submitted by a first user, and in still another embodiment, only certain classes of users are permitted to provide feedback on answers submitted. It is generally not permitted for the user who submitted the answer to provide feedback on the user's own answer because of the obvious conflict of interest.

The volunteer tracking module 114 tracks the volunteer time earned by each user for submitting answers to questions. In one embodiment, a small increment of time is awarded to every user for each question that the user answers, for example 5 minutes. In another embodiment, the amount of time earned by the user is adjusted based on the type of question that is posed, the subject matter of the question, the length of the response, the timeliness of the response, the experience level of the user answering the question, or any other criteria that can be tracked by the social learning platform 110.

The question/answer database 115 stores the questions and the respective answers that have been submitted to the social learning platform 110 by the users. The question/answer database 115 may also store the status of each question and answer, as applicable.

The user database 116 stores the profile information of a user, including authentication information (e.g., username and password), contact information, the user's contributions to the platform (e.g., number of answers submitted, number of answers that received feedback as being helpful, the user's reputation, score, ranking, or achievements), and the amount of volunteer time that has been earned. Optionally, the user database 116 may also maintain user preferences or other account settings that customize how the user views or interacts with the social learning platform 110.

The network 101 represents the communication pathways between the user devices 102 and the social learning platform 110. In one embodiment, the network 101 uses standard Internet communications technologies and/or protocols.

### Tracking Volunteer Time

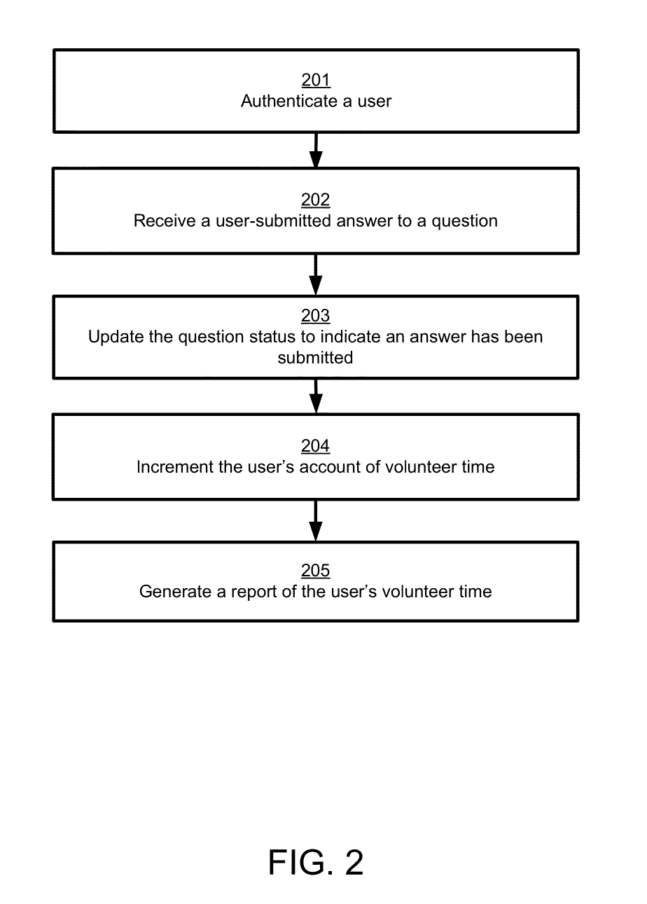

FIG. 2 is a flow chart illustrating a method of tracking volunteer time for submitting answers to questions on a social learning platform, in accordance with an embodiment of the invention. In some implementations, the steps are performed in an order other than the order presented in FIG. 2, and in other implementations, additional or alternative steps may be performed.

In step 201, a user is authenticated, for example by the social learning platform 110 authenticating the user's login to the platform. Any technique for authenticating a user known to those of skill in the art can be used. In one embodiment, the integrity of the volunteer tracking system requires that users who want credit for submitting answers to questions on the social learning platform 110 identify themselves so that their answers can be properly credited to their accounts.

In step 202, a user-submitted answer to a question is received. For example, the user-submitted answer may be received through a user interface displayed by the user interface module 111 of the social learning platform 110.

In step 203, the question status is updated to indicate that an answer has been submitted. For example, the question status may be changed from “unanswered’ to “answered” responsive to the submitted answer, or the number of submitted answers to the question may be incremented in response to the user's answer.

In step 204, the user's account of volunteer time is incremented. As discussed above, the amount of the increment may be determined by the type of question answered, the subject matter of the question, the length of the answer, the timeliness of the answer, or other possible criteria. In one embodiment, volunteer tracking module 114 determines the amount of the increment and updates the user's account of volunteer time stored in the user database accordingly.

In step 205, a report of the user's volunteer time is generated. In one embodiment, the volunteer tracking module 114 generates a report for display in the user interface of the social learning platform 110 for the user's information. In other embodiments, the report is generated and sent from the platform to a destination selected by the user, for example, an administrator or guidance counselor at the user's school, an email address of the user, or any other destination.

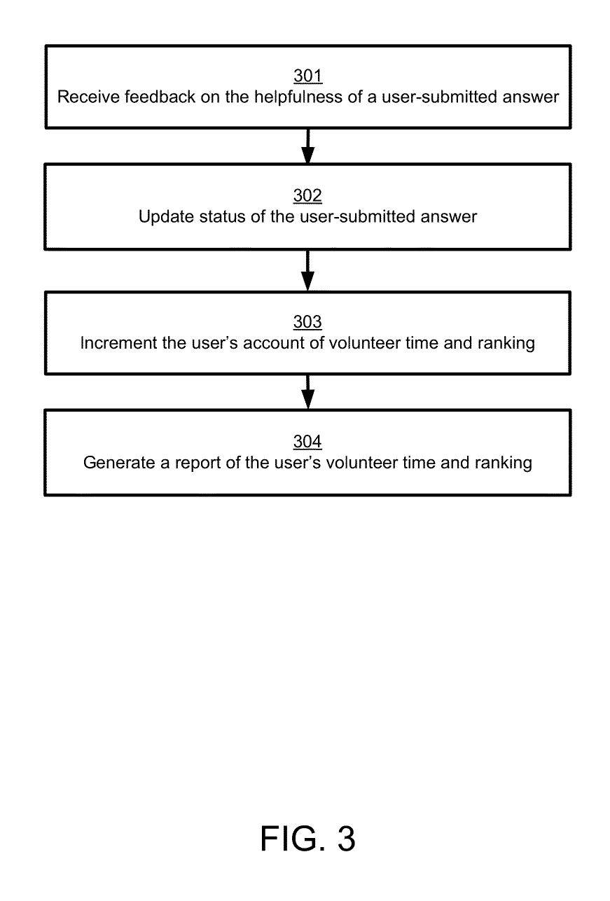

FIG. 3 is a flow chart illustrating a method of rewarding a user for helpful answers to questions on a social learning platform, in accordance with an embodiment of the invention. In some implementations, the steps are performed in an order other than the order presented in FIG. 3, and in other implementations, additional or alternative steps may be performed.

In step 301, feedback on the helpfulness of a user-submitted answer is received. In one embodiment, only the user who asked the question can submit feedback on whether the answer was helpful. In other embodiments, any other subsequent reader of the answer can submit feedback. In one implementation, the feedback may be positive or negative. The user can indicate whether the answer was helpful or if the answer was not helpful, for example, because the explanation was unclear, only a partial answer was provided, etc. In one embodiment, in any of these circumstances, the user who submitted the question can mark the answer as “cloudy” to indicate that that the answer was not helpful, and may be required to provide additional information to explain what is unclear about the response. In some cases, the user can rate the answer on a scale, or use other terminology to express the helpful or unhelpful nature of an answer.

In step 302, responsive to the feedback, the status of the user-submitted answer is updated. For example, if the user who submitted the question marked the submitted answer as helpful in the user interface of the social learning platform 110, the answer status module 113 updates the status of the answer to indicate it was helpful. If the submitted answer is marked as unhelpful by the user who submitted the question, the answer status module 113 updates the status of the answer as unhelpful. Similarly, in implementations using a ration scale, the answer's score on the rating scale is used to update the answer's status.

In step 303, provided that the feedback on the helpfulness of the user-submitted answer was positive, the user who submitted the answer may receive a bonus increment of volunteer time as a reward for the high quality answer. In one embodiment, the bonus may be a few extra minutes of volunteer time added to the user's account. In one embodiment, the bonus amount may be determined by the answer's score on the rating scale. In an alternate embodiment, if feedback on the helpfulness of the user-submitted response was negative, the user's account may not be changed, or the amount previously earned by the user for the response may be decreased or removed from the user's account. In one embodiment, the user's ranking within the platform is based on the accumulated feedback the user has received on the user-submitted answers. Thus, the user's ranking may also be incremented or updated responsive to the received feedback. In some embodiments, the volunteer time awarded is increased as the user ranking goes up within the platform.

In step 304, a report of the user's volunteer time and ranking is generated. As described above with reference to step 205, in one embodiment, the volunteer tracking module 114 generates a report for display in the user interface of the social learning platform 110 for the user's information. In other embodiments, the report is generated and sent from the platform to a destination selected by the user, for example, an administrator or guidance counselor at the user's school, or an email address of the user.

### User Interface

FIG. 4 is an example user interface for a subject dashboard of a social learning platform, in accordance with an embodiment of the invention. In this example, the questions are divided into the academic subject areas of Biology, Business, Chemistry, History, Literature, Math, and Physics. In other examples, more, fewer, or different academic subject areas may used. For each subject area, the user interface provides a summary of the number of questions in that subject area, a count of all questions which do not have any answer (referred to in this example as “open” questions), and a count of all questions which have only cloudy answers. In this example, each of these entries is a hyperlink which directs the user to the corresponding questions.

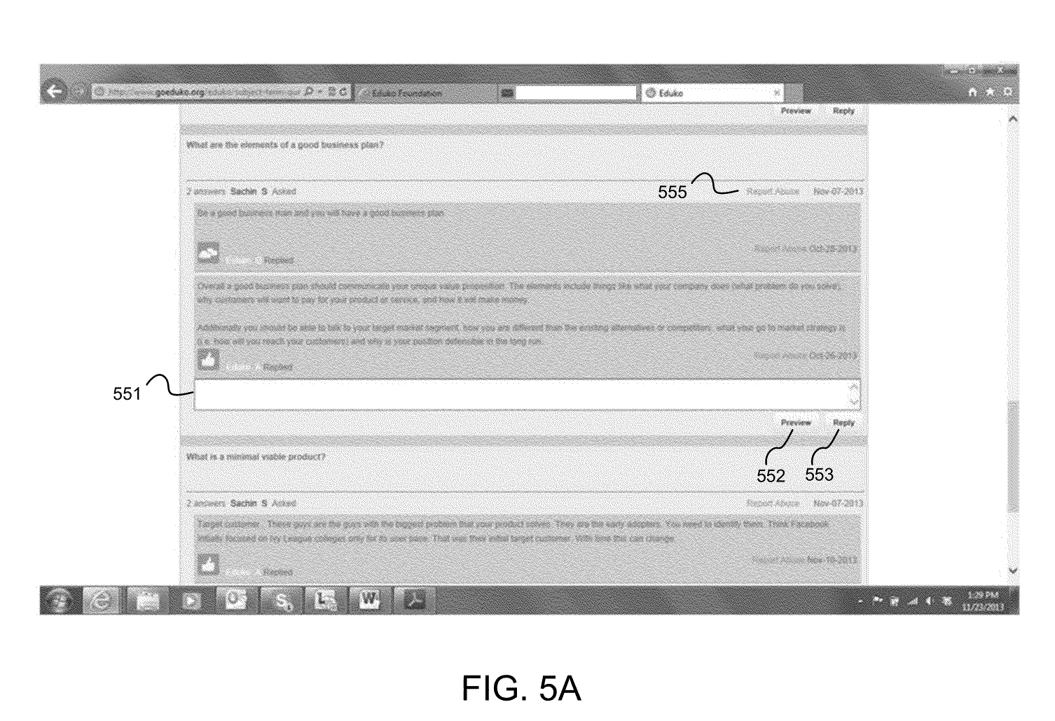

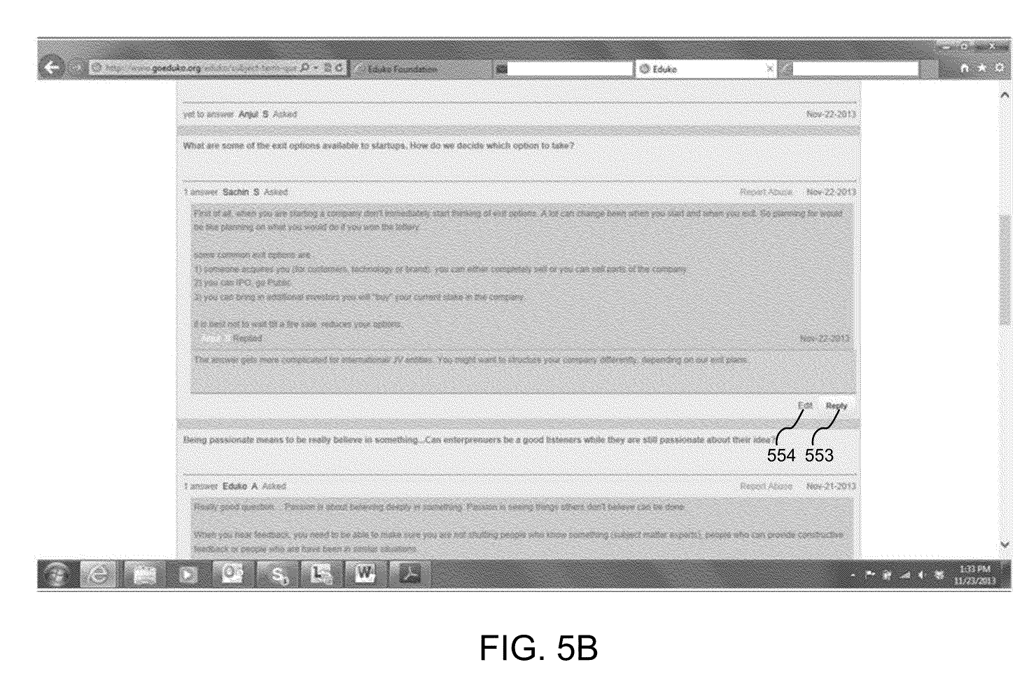

FIGS. 5A and 5B are example user interfaces for answering a question on a social learning platform, in accordance with an embodiment of the invention. A user can scroll through the asked questions and the offered answers for a subject, such as business, until finding a question to which the user wants to submit an answer. The user can enter the answer into the text entry box 551 as demonstrated in FIG. 5A, and then optionally preview the answer by selecting the preview button 552 to check formatting and the layout of how it will appear, and submit the answer by selecting the “Reply” button 553. Any user can select “Report Abuse” 555 next to any item to flag the corresponding question or answer as inappropriate. In one implementation, in response to a user flagging a question or answer, the social learning platform 110 immediately removes the flagged item from the user interface. After an internal review process, the platform 110 can either delete the item or republish it. FIG. 5B is an example user interface for previewing the answer a user has entered before submitting it. If the user wants to make further changes to the user's answer, the user may select the “Edit” button 554. If the user is satisfied with the previewed answer, the user can select the “Reply” button 553 to submit the answer.

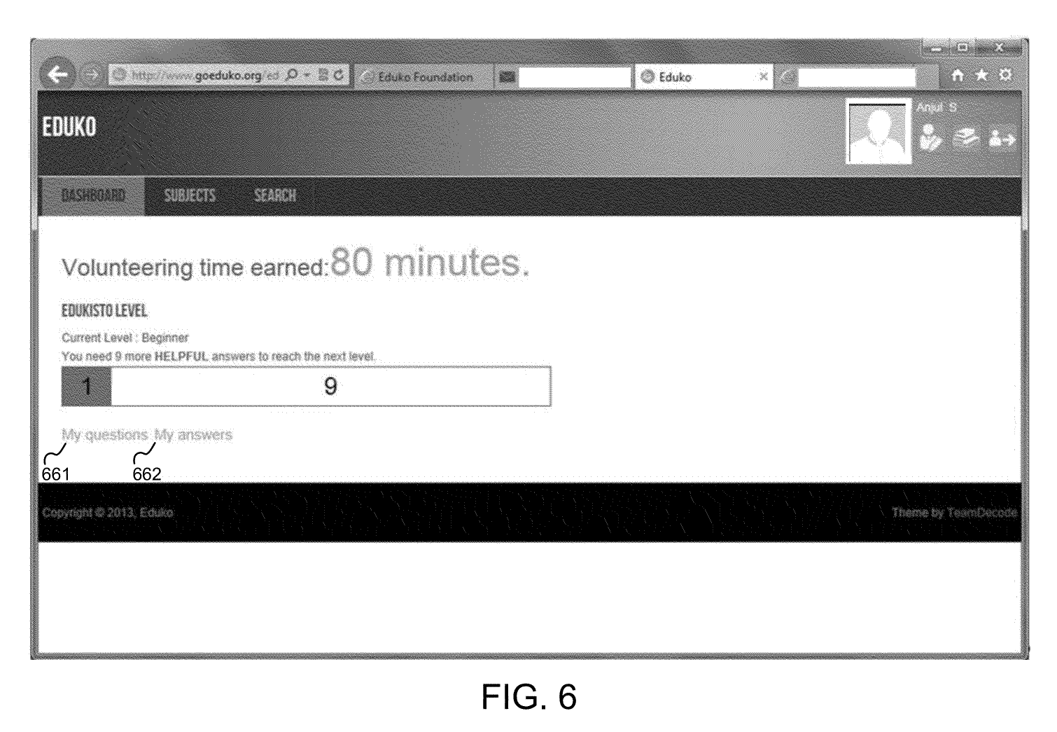

FIG. 6 is an example user interface for a member dashboard on a social learning platform showing accumulated volunteering time, in accordance with an embodiment of the invention. In this example, the user has earned 80 minutes of volunteering time. In the example shown in FIG. 6, the user is rated as a “Beginner” and needs 9 more helpful answers to reach the next level. The user has already earned 1 helpful answer for the user's contributions. By selecting the “My questions” link 661, the user can be taken directly to a filtered list of the user's submitted questions. By selecting the “My answers” link 662, the user can be taken directly to a filtered list of the user's submitted answers.

Optionally, the user interface may also include leaderboards or other reports as part of an incentive system to deepen the volunteers' engagement with the social learning platform 110. The leaderboards may report the current relative standings of volunteers who are participating in friendly competitions. The volunteers may be ranked in order, for example, by amount of volunteer time, by number of questions answered, by the number of answers judged to be helpful, or any other measure of contributions tracked by the social learning platform 110. In one implementation, leaderboards show world-wide rankings, and in other implementations, separate leaderboards may be maintained for any subgroup of users of the platform, for example a group of volunteers from the same school, from the same city, from the same region, from the same state, from the same country. In yet other implementations, users may choose to show others the metrics describing their contributions on the social earning platform 110 or share their progress with others on other social media platforms.

### Physical Components of a Computer

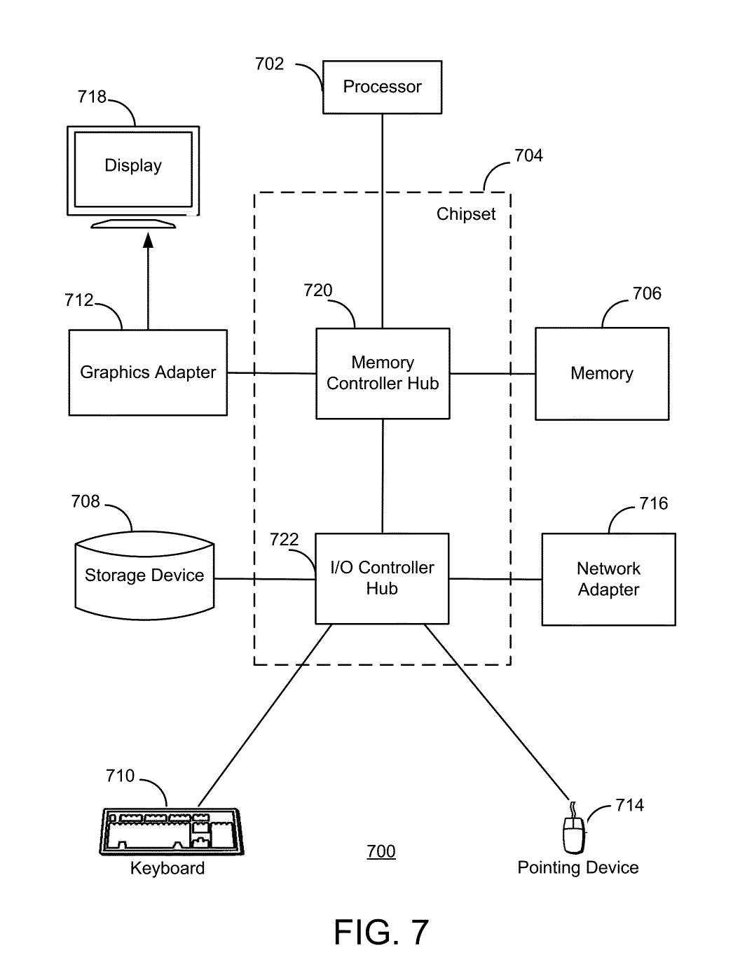

FIG. 7 is a high-level block diagram of the components of a computing system 700 for use, for example, as the social learning platform 110 or user devices 102 depicted in FIG. 1, in accordance with an embodiment. Illustrated are at least one processor 702 coupled to a chipset 704. Also coupled to the chipset 704 are a memory 706, a storage device 708, a keyboard 710, a graphics adapter 712, a pointing device 714, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is any non-transitory computer-readable storage medium, such as a hard drive, compact disk read-only memory (CD-ROM), DVD, or a solid-state memory device. The memory 706 holds instructions and data used by the processor 702. The pointing device 714 may be a mouse, track ball, or other type of pointing device, and is used in combination with the keyboard 710 to input data into the computer 700. The graphics adapter 712 displays images and other information on the display 718. The network adapter 716 couples the computer 700 to a network.

As is known in the art, a computer 700 can have different and/or other components than those shown in FIG. 7. In addition, the computer 700 can lack certain illustrated components. In one embodiment, a computer 700 acting as the social learning platform 110 may lack a keyboard 710, pointing device 714, graphics adapter 712, and/or display 718. Moreover, the storage device 708 can be local and/or remote from the computer 700 (such as embodied within a storage area network (SAN)).

As is known in the art, the computer 700 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 708, loaded into the memory 706, and executed by the processor 702.

Embodiments of the physical components described herein can include other and/or different modules than the ones described here. In addition, the functionality attributed to the modules can be performed by other or different modules in other embodiments. Moreover, this description occasionally omits the term “module” for purposes of clarity and convenience.

### Additional Configuration Considerations

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A computer-implemented method comprising:
authenticating a user, the user associated with an account on a social learning platform;
receiving a user-submitted answer to a question on the social learning platform;
incrementing the user's account of volunteer time; and
generating a report of the user's volunteer time.

2. The method of claim 1, further comprising responsive to receiving a user submitted answer to the question, updating a status of the question to indicate an answer has been submitted.

3. The method of claim 1, further comprising sending the report to a destination selected by the user.

4. The method of claim 1, wherein incrementing the user's account of volunteer time comprises adding an amount of time to the user's account and the amount of time depends on at least one selected from a group consisting of type of the question and subject matter of the question.

5. The method of claim 1, wherein incrementing the user's account of volunteer time comprises adding an amount of time to the user's account and the amount of time depends at least partially on length of the user-submitted answer.

6. The method of claim 1, wherein incrementing the user's account of volunteer time comprises adding an amount of time to the user's account and the amount of time depends at least partially on timeliness of the user-submitted answer.

7. The method of claim 1, wherein incrementing the user's account of volunteer time comprises adding an amount of time to the user's account and the amount of time depends at least partially on an experience level of the user.

8. The method of claim 1, further comprising:
receiving feedback on the user-submitted answer; and
responsive to the feedback, updating a status of the user-submitted answer.

9. The method of claim 8, further comprising:
responsive to the feedback being positive, further incrementing the user's account of volunteer time.

10. The method of claim 1, further comprising:
responsive to a report of an inappropriate question or answer, removing the question or answer from a user interface of the social learning platform.

11. A nontransitory computer readable storage medium including computer program instructions that, when executed, cause a computer processor to perform operations comprising:
authenticating a user, the user associated with an account on a social learning platform;
receiving a user-submitted answer to a question on the social learning platform;
incrementing the user's account of volunteer time; and
generating a report of the user's volunteer time.

12. The medium of claim 11, wherein the operations further comprise responsive to receiving a user submitted answer to the question, updating a status of the question to indicate an answer has been submitted.

13. The medium of claim 11, wherein the operations further comprise sending the report to a destination selected by the user.

14. The medium of claim 11, wherein incrementing the user's account of volunteer time comprises adding an amount of time to the user's account and the amount of time depends on at least one selected from a group consisting of type of the question and subject matter of the question.

15. The medium of claim 11, wherein incrementing the user's account of volunteer time comprises adding an amount of time to the user's account and the amount of time depends at least partially on length of the user-submitted answer.

16. The medium of claim 11, wherein incrementing the user's account of volunteer time comprises adding an amount of time to the user's account and the amount of time depends at least partially on timeliness of the user-submitted answer.

17. The medium of claim 11, wherein incrementing the user's account of volunteer time comprises adding an amount of time to the user's account and the amount of time depends at least partially on an experience level of the user.

18. The medium of claim 11, wherein the operations further comprise:
receiving feedback on the user-submitted answer; and
responsive to the feedback, updating a status of the user-submitted answer.

19. The medium of claim 18, wherein the operations further comprise:
responsive to the feedback being positive, further incrementing the user's account of volunteer time.

20. A system comprising:
a computer processor; and
a computer readable storage medium storing processor-executable computer program instructions, the computer program instructions comprising instructions for:
authenticating a user, the user associated with an account on a social learning platform;
receiving a user-submitted answer to a question on the social learning platform;
incrementing the user's account of volunteer time; and
generating a report of the user's volunteer time.
